(19) United States
(12) Patent Application Publication
(10) Pub. No.: US 2017/0286785 A1
(43) Pub. Date: Oct. 5, 2017

(54) INTERACTIVE DISPLAY BASED ON INTERPRETING DRIVER ACTIONS

(71) Applicant: Ford Global Technologies, LLC, Dearborn, MI (US)

(72) Inventors: Daniel Mark Schaffer, Brighton, MI (US); Kenneth James Miller, Canton, MI (US); Filip Tomik, Milford, MI (US)

(21) Appl. No.: 15/091,340

(22) Filed: Apr. 5, 2016

(51) Int. Cl. G06K 9/00; B60K 35/00; G06F 3/16

(52) U.S. Cl. CPC G06K 9/00845; G06F 3/167; G06K 9/00355; B60K 35/00; B60K 2350/1004; B60K 2350/1052; B60K 2350/108

(57) ABSTRACT

Systems and methods for an interactive display based on interpreting driver actions are disclosed. An example disclosed vehicle includes a camera, a microphone, and a vehicle assist unit. The example vehicle assist unit is configured to in response to detecting a request for information regarding a subsystem of the vehicle via at least one of the camera or the microphone, display information about the subsystem at a first level of detail, and in response to detecting a request for more information regarding the subsystem, display information about the subsystem at second level of detail.

### TECHNICAL FIELD

The present disclosure generally relates to controls of a vehicle and, more specifically, an interactive display based on interpreting driver actions.

### BACKGROUND

As vehicles are manufactured with complex systems with many options, drivers can get overwhelmed by the knowledge necessary to operate the vehicle to gain the benefits of the new systems. Owner's manuals can be hard to understand. Dealers review the features of the vehicle with the driver, but often drivers do not remember all of the information and do not care about it until they want to use a particular feature.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments for systems and methods for an interactive display based on interpreting driver actions are disclosed. An example disclosed vehicle includes a camera, a microphone, and a vehicle assist unit. The example vehicle assist unit is configured to in response to detecting a request for information regarding a subsystem of the vehicle via at least one of the camera or the microphone, display information about the subsystem at a first level of detail, and in response to detecting a request for more information regarding the subsystem, display information about the subsystem at second level of detail.

An example disclosed method includes, in response to detecting a request for information regarding a subsystem of a vehicle via at least one of a camera or a microphone, displaying, on a center console display of the vehicle, information about the subsystem at a first level of detail. Additionally, the example method includes, in response to detecting a request for more information regarding the subsystem, displaying, on the center console display of the vehicle, information about the subsystem at second level of detail.

An example disclosed tangible computer readable medium comprises instructions that, when executed, cause a vehicle to, in response to detecting a request for information regarding a subsystem of a vehicle via at least one of a camera or a microphone, display, on a center console display of the vehicle, information about the subsystem at a first level of detail. The example disclosed instructions, when executed, cause the vehicle to, in response to detecting a request for more information regarding the subsystem, display, on the center console display of the vehicle, information about the subsystem at second level of detail.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a system to provide an interactive display based on interpreting driver actions in accordance with the teachings of this disclosure.

FIG. 2 illustrates a cabin of a vehicle with the interaction display of FIG. 1.

FIG. 3 depicts electronic components to implement the vehicle assistance unit of FIG. 1.

FIG. 4 is a flowchart depicting an example method to provide the vehicle assistance unit of FIG. 1 that maybe implemented by the electronic components of FIG. 3.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As disclosed herein, a vehicle provides an interactive display to guide a driver when using controls and features of the vehicle. The vehicle uses cameras, microphones and/or other sensory data to monitor the behavior of the driver to determine when the driver would benefit from more information regarding a control or a feature. Movement patterns indicative of confusion, such as repeatedly reaching for a control, are identified. In response to the vehicle detecting that the driver is confused, the driver displays information regarding the particular control on a display, such as the center console display of an infotainment head unit, at a first level of detail. For example, the first level of detail may include information from the user's manual. In some examples, the driver may verbally request more information. Alternatively or additionally, in some examples, the vehicle may detect that the movement of the driver indicates the driver is still confused. In such examples, the vehicle displays information regarding the control at a second level of detail. For example, the vehicle may present a video tutorial on how to use the particular control.

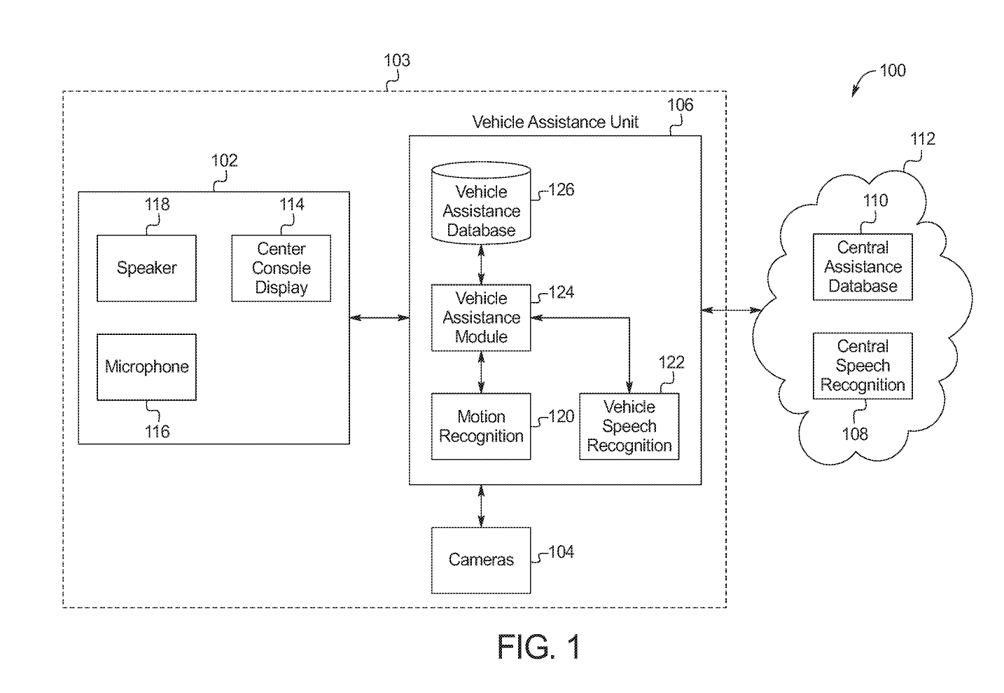

FIG. 1 illustrates a system 100 to provide an interactive display based on interpreting driver actions in accordance with the teachings of this disclosure. In the illustrated examples, the system 100 includes an infotainment head unit 102 inside a vehicle 103 one or more cameras 104, a vehicle assistance unit 106 inside the vehicle 103, and services 108 and 110 residing on a network 112. The vehicle 103 may be a standard gasoline powered vehicle, a hybrid vehicle, an electric vehicle, a fuel cell vehicle, or any other mobility implement type of vehicle. The vehicle 103 may be non-autonomous or semi-autonomous. The vehicle 103 includes parts related to mobility, such as a powertrain with an engine, a transmission, a suspension, a driveshaft, and/or wheels, etc.

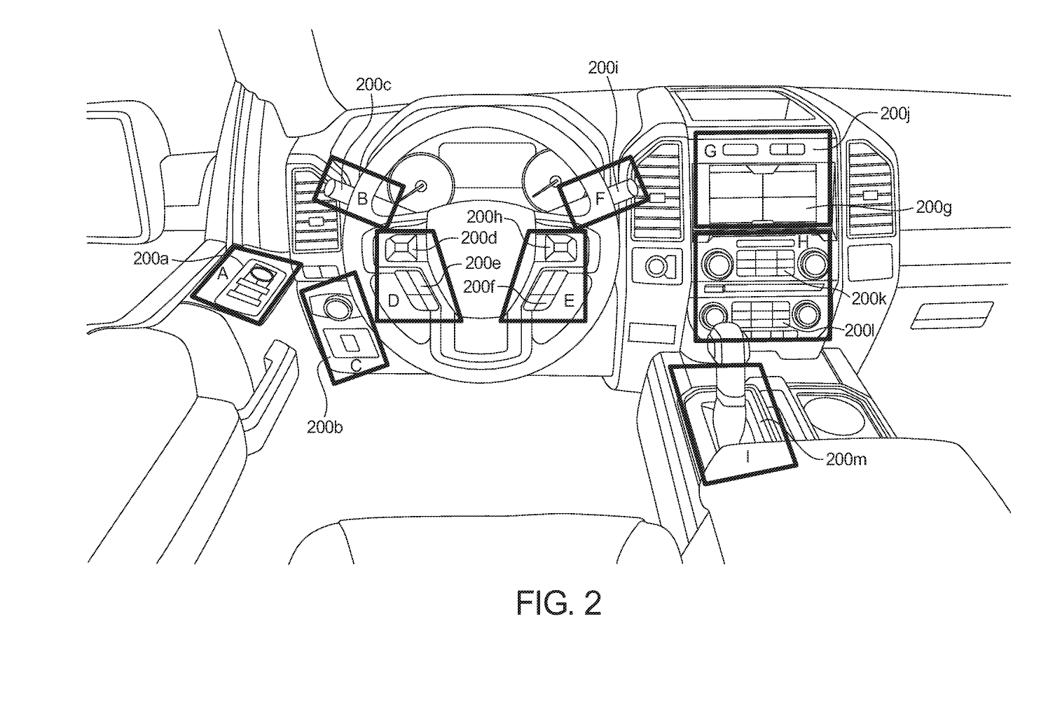

The infotainment head unit 102 provides an interface between the vehicle 103 and a user (e.g., a driver, a passenger, etc.). In the illustrated examples, the infotainment head unit 102 includes a center console display 114, a microphone 116, and one or more speakers 118. The infotainment head unit 102 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. In some examples, one or more command inputs 200a to 200m of FIG. 2 are located on the infotainment head unit 102. The output devices may include instrument cluster outputs (e.g., dials, lighting devices), actuators, a dashboard panel, a heads-up display, the center console display 114 (e.g., a liquid crystal display (“LCD”), an organic light emitting diode (“OLED”) display, a flat panel display, a solid state display, or a heads-up display), and/or the speakers 118. The microphone 116 is positioned on the infotainment head unit 102 so to capture the voice of the driver.

The camera(s) 104 is/are positioned in the cabin of the vehicle 103. As shown in FIG. 2, the camera(s) 104 is/are positioned to monitor one or more zones (e.g., the zones A through F) corresponding to command inputs 200a to 200m of the vehicle 103. Additionally, the camera(s) 104 may be positioned to be used by multiple systems other than the system 100, such as a driver recognition system or a driver impairment detection system. In some examples, one of the cameras 104 is positioned on a housing of a rear view mirror. Alternatively or additionally, one of the cameras 104 is positioned on a housing of a dome roof light panel.

The vehicle assistance unit 106 monitors the gestures and the voice of a user of the vehicle 103 to determine when to display information on the center console display 114. In the illustrated example of FIG. 1, the vehicle assistance unit 106 includes a motion recognition module 120, a speech recognition module 122, a vehicle assist module 124, and a vehicle assistance database 126.

The motion recognition module 120 is commutatively coupled to the camera(s) 104. The motion recognition module 120 monitors the zones A through I of FIG. 2 for the hands of the occupants of the vehicle 103 using gesture recognition. In some examples, the motion recognition module 120 tracks items and/or body parts other than the hand(s) of the driver. The motion recognition module 120 determines the location of a user's hands and/or fingers within the zones A through F. Additionally, the motion recognition module 120 is contextually aware of the locations of the command inputs 200a to 200m. For example, if a hand is in zone F, the motion recognition module 120 may determine that the hand is near the gear shifter and four-wheel drive (4WD) control. In some examples, the specificity of such proximate command data may depend on how close the hand is to any particular control. For example, the motion recognition module 120 may determine that the hand is touching the 4WD control. In such a manner, the motion recognition module 120 provides hand position data and the proximate command data to the vehicle assist module 124.

The speech recognition module 122 is communicatively coupled to the microphone 116. The speech recognition module 122 provides speech recognition to the vehicle assist module 124. The speech recognition module 122 passively listens for a prompt phrase from a user. For example, the prompt phrase may be “Help Me Henry.” In some examples, the speech recognition module 122 informs the vehicle assist module 124 after recognizing the prompt phrase. Alternatively or additionally, in some examples, the speech recognition module 122 listens for a command and/or a phrase. In some such examples, the speech recognition module 122 recognizes a list of words related to the commands and/or features of the vehicle 103. In such examples, the speech recognition module 122 provides command data to the vehicle assist module 124 identifying the command and/or features specified by the command and/or phrase spoken by the user. For example, the speech recognition module 122 may recognize “four wheel drive” and “bed light,” etc.

Alternatively or additionally, in some examples, the speech recognition module 122 may be communicatively coupled to a central speech recognition service 108 on the network 112. In such examples, the speech recognition module 122, in conjunction with the central speech recognition service 108, recognizes phrases and/or natural speech. In some examples, the speech recognition module 122 sends speech data to the central speech recognition service 108 and the central speech recognition service 108 returns voice command data with the commands and/or features specified by the speech data. For example, if the user says “Help me Henry. Show me how the four-wheel drive works,” the voice command data would indicate that the user inquired about the 4WD subsystem.

In some examples, the speech recognition module 122 also includes voice recognition. In such examples, during an initial setup procedure, the speech recognition module 122 is trained to recognize the voice of a particular user or users. In such a manner, the speech recognition module 122, for example, only will respond to the prompt phrase when spoken by the particular user or users so that other sources (e.g., the radio, children, etc.) do not activate speech voice recognition capabilities of the speech recognition module 122.

The vehicle assist module 124 determines when to display information about a command or feature one of the displays (e.g., the center console display 114) of the infotainment head unit 102. The vehicle assist module 124 is communicatively coupled to the motion recognition module 120 and the speech recognition module 122. The vehicle assist module 124 receives or otherwise retrieves the hand position data and the proximate command data from the motion recognition module 120. The vehicle assist module 124 receives or otherwise retrieves the voice command data from the speech recognition module 122. In some examples, the vehicle assist module 124 tracks which commands have been accessed (e.g., activated, changed, etc.).

Based on the hand position data, the proximate command data and/or the voice command data, vehicle assist module 124 determines when a user would benefit from help regarding a command. In some examples, the vehicle assist module 124 determines to display information when the hand data and/or the proximate command data indicate that the hand of the user (a) has lingered near or touched one of the command inputs 200a to 200m (e.g., a button, a knob, a stick control, etc.) for a threshold amount of time (e.g., five seconds, ten seconds, etc.) or (b) has approached one of the command inputs 200a to 200m a threshold number of times (e.g., three times, five times, etc.) in a period of time (e.g., fifteen seconds, thirty seconds, etc.). For example, the vehicle assist module 124 may display information regarding the light controls when the hand of the user lingers near the vehicle lighting control stick.

In some examples, the vehicle assist module 124 determines to display information when (i) the hand data and/or the proximate command data indicate that the hand of the user is near one of the command inputs 200a to 200m, and (ii) voice command data indicates that the user said the prompt phrase. For example, the vehicle assist module 124 may display information regarding vehicle modes (e.g., eco mode, sporty mode, comfort mode, etc.) when the hand data and/or the proximate command data indicate the hand of the user is touching the mode control button while the user said, “Help me Henry.”

In some examples, the vehicle assist module 124 determines to display information when the voice command data indicates that the user inquires about a particular control and or feature. For examples, the vehicle assist module 124 may display information regarding Bluetooth® setup; the voice command data indicates that the user inquired about the Bluetooth® subsystem. In some examples, the vehicle assist module 124 determines to display information when the settings of one of the command inputs 200a to 200m changes a threshold number of times (e.g., three times, five times, etc.) over a period of time (e.g., fifteen seconds, thirty seconds, etc.). For example, the vehicle assist module 124 may display information regarding front and rear wiper controls in response to the front and rear wiper controls being changed frequently in a short period of time.

Initially, in response to determining to display information, the vehicle assist module 124 displays information at a first level of detail. The first level of detail includes (a) information in the driver's manual, (b) high-level summaries of the relevant controls (e.g. as indicated by the hand position data, the proximate command data and/or the voice command data, etc.) and/or (c) major functionality (e.g., how to turn on and off the fog lamps, how to adjust wiper speed, etc.) of the relevant controls, etc. In the illustrated example of FIG. 1, the information for the first level of detail is stored in the vehicle assistance database 126. The vehicle assistance database 126 is any suitable data structure (e.g., a relational database, a flat file, etc.) used to store data in a searchable manner. For example, the vehicle assistance database 126 may include an entry for heating, ventilation, and air conditioning (HVAC) controls with images, text and/or sound recordings. In some examples, the vehicle assistance database 126 receives updates from a central assistance database 110 from time to time.

When displaying the first level of information, the vehicle assist module 124, via the motion recognition module 120 and the speech recognition module 122, monitors the user(s) in the cabin of the vehicle 103. In response to the hand position data, the proximate command data and/or the voice command data indicating that the user is still confused about the control function related to the information being displayed at the first level of detail (e.g. using the techniques described above), the vehicle assist module 124 displays information regarding the control function at a second level of detail. For example, if, at a first time, the vehicle assist module 124 is displaying information regarding the HVAC controls at a first level of detail, and at a second time, the motion recognition module 120 detects the hand of the user lingering near the HVAC controls, the vehicle assist module 124 may display information regarding the HVAC controls at a second level of detail. In some examples, when the vehicle assist module 124 is displaying information at the first level of detail, the speech recognition module 122 recognizes a second prompt phrase (e.g., “More info Henry,” etc.). In such examples, the vehicle assist module 124 displays information regarding the control function at the second level of detail regardless of the position of the hand of the user.

In the illustrated example, the vehicle assist module 124 is communicatively coupled to the central assistance database 110. The central assistance database 110 includes the information at the second level of detail. The second level detail may include (a) videos, (b) real-time compiled information based on customer comments to call centers and/or online centers, (c) summary of dealer technical comments, and/or (d) compiled online user sources (forums, websites, tutorials, etc.), etc. The central assistance database 110 is maintained by any suitable entity that provides trouble shooting help to driver (e.g., vehicle manufacturers, third party technical support companies, etc.).

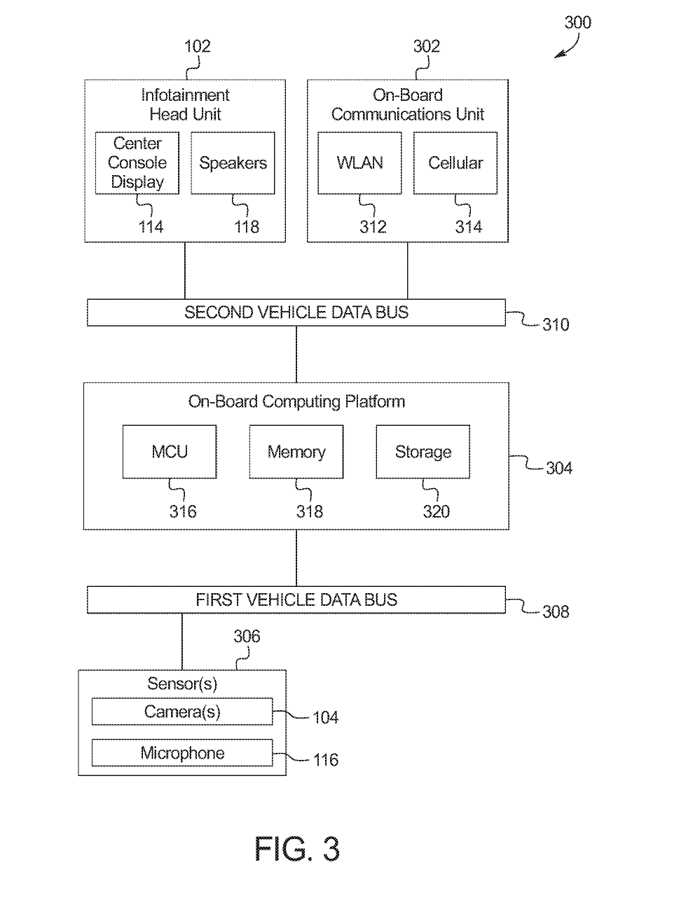

FIG. 3 depicts electronic components 300 to implement the vehicle assistance unit of FIG. 1. In the illustrated example, the electronic components 300 include an on-board communications platform 302, the infotainment head unit 102, an on-board computing platform 304, sensors 306, a first vehicle data bus 308, and a second vehicle data bus 310.

The on-board communications platform 302 includes wired or wireless network interfaces to enable communication with the external networks 112. The on-board communications platform 302 also includes hardware (e.g., processors, memory, storage, antenna, etc.) and software to control the wired or wireless network interfaces. The on-board communications platform 302 includes local area wireless network controllers 312 (including IEEE 802.11 a/b/g/n/ac or others) and/or one or more cellular controllers 314 for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m), and Wireless Gigabit (IEEE 802.11ad), etc.). The on-board communications platform 302 may also include a global positioning system (GPS) receiver and/or short-range wireless communication controller(s) (e.g. Bluetooth®, Zigbee®, near field communication, etc.).

Further, the external network(s) 112 may be a public network, such as the Internet; a private network, such as an intranet; or combinations thereof, and may utilize a variety of networking protocols now available or later developed including, but not limited to, TCP/IP-based networking protocols. In some examples, the central speech recognition service 108 and the central assistance database 110 are hosted on servers connected to the external network(s) 112. For example, the central speech recognition service 108 and the central assistance database 110 may be hosted by a cloud provider (e.g., Microsoft Azure, Google Cloud Computing, Amazon Web Services, etc.). The speech recognition module 122 is communicatively coupled to the central speech recognition service 108 via the on-board communications platform 302. Additionally, the vehicle assist module 124 is communicatively coupled to the central assistance database 110 via the on-board communications platform 302. The on-board communications platform 302 may also include a wired or wireless interface to enable direct communication with an electronic device (such as, a smart phone, a tablet computer, a laptop, etc.).

The on-board computing platform 304 includes a processor or controller 316, memory 318, and storage 320. The on-board computing platform 304 is structured to include the motion recognition module 120, the speech recognition module 122, and/or the vehicle assist module 124. Alternatively, in some examples, one or more of the motion recognition module 120, the speech recognition module 122, and/or the vehicle assist module 124 may be an electronic control unit with separate processor(s), memory and/or storage. The processor or controller 316 may be any suitable processing device or set of processing devices such as, but not limited to: a microprocessor, a microcontroller-based platform, a suitable integrated circuit, one or more field programmable gate arrays (FPGAs), or one or more application-specific integrated circuits (ASICs). The memory 318 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), and read-only memory. In some examples, the memory 318 includes multiple kinds of memory, particularly volatile memory and non-volatile memory. The storage 320 may include any high-capacity storage device, such as a hard drive, and/or a solid state drive. In some examples, the storage 320 includes the vehicle assistance database 126.

The memory 318 and the storage 320 are a computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 318, the computer readable medium, and/or within the controller 316 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 306 may be arranged in and around the cabin of the vehicle 103 in any suitable fashion. In the illustrated example, the sensors 306 include the camera(s) 104 and the microphone 116. The camera(s) 104 is/are positioned in the cabin to capture the command inputs 200a through 200m when the driver is in the driver's seat. For example, one of the camera(s) 104 may be positioned in the housing of the rear view mirror and/or one of the camera(s) 104 may be positioned on the housing of the roof light dome. The microphone 116 is positioned to capture the voice of the driver of the vehicle 103. For example, the microphone 116 may be positioned on the steering wheel or any other suitable location (e.g., the infotainment head unit 102, etc.) for in-vehicle voice recognition systems.

The first vehicle data bus 308 communicatively couples the sensors 306, the on-board computing platform 304, and other devices connected to the first vehicle data bus 308. In some examples, the first vehicle data bus 308 is implemented in accordance with the controller area network (CAN) bus protocol as defined by International Standards Organization (ISO) 11898-1. Alternatively, in some examples, the first vehicle data bus 308 may be a Media Oriented Systems Transport (MOST) bus, or a CAN flexible data (CAN-FD) bus (ISO 11898-7). The second vehicle data bus 310 communicatively couples the on-board communications platform 302, the infotainment head unit 102, and the on-board computing platform 304. The second vehicle data bus 310 may be a MOST bus, a CAN-FD bus, or an Ethernet bus. In some examples, the on-board computing platform 304 communicatively isolates the first vehicle data bus 308 and the second vehicle data bus 310 (e.g., via firewalls, message brokers, etc.). Alternatively, in some examples, the first vehicle data bus 308 and the second vehicle data bus 310 are the same data bus.

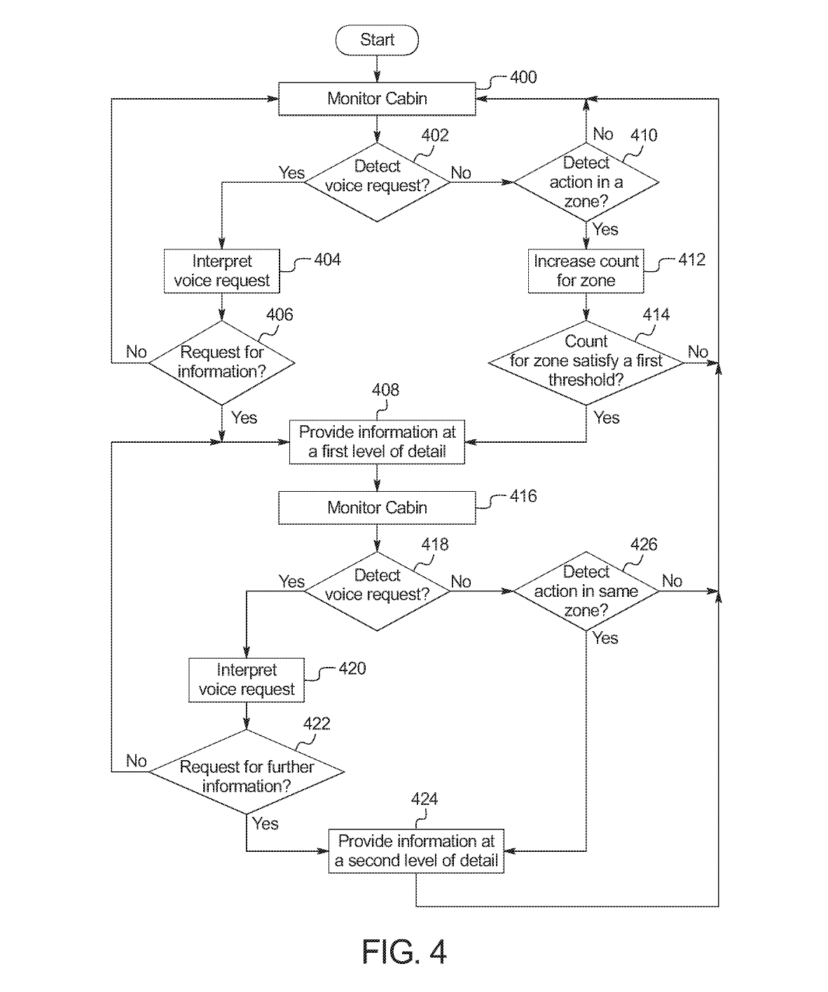

FIG. 4 is a flowchart depicting an example method to provide the vehicle assistance unit 106 of FIG. 1 that may be implemented by the electronic components 300 of FIG. 3. Initially, vehicle assist module 124, via the sensors 306 (e.g., the camera(s) 104, the microphone 116, etc.), monitors the cabin of the vehicle 103 (block 400). The speech recognition module 122 listens for if a user (e.g., a driver, a passenger, etc.) has said the prompt phrase (block 402). If the speech recognition module 122 determines that the user has said the prompt phrase, the speech recognition module 122 interprets the speech following the prompt phrase (block 404). In some examples, the speech recognition module 122 sends the speech after the prompt phrase to the central speech recognition service 108 for further processing (e.g., to interpret natural language, etc.). The speech recognition module 122 determines whether the user requested information regarding a subsystem and/or one of the command inputs 200a through 200m (block 406). If the speech recognition module 122 determines that the user did request information, the vehicle assist module 124 displays (e.g., via the center console display 114) relevant information at a first level of detail (block 408). For example, if the user said “Help me Henry, where is the fog lamp switch,” the vehicle assist module 124 may display user manual page(s) about the fog lamp switch. In some examples, the information at the first level of detail is stored in the vehicle assistance database 126. If the speech recognition module 122 determines that the user did not request information, the vehicle assist module 124 continues to monitor the cabin (block 400).

If the speech recognition module 122 determines that the user has not said the prompt phrase at block 402, the motion recognition module 120 determines if the hand of the driver is within one of the zones A through I and/or proximate one of the command inputs 200a through 200m (block 410). If the motion recognition module 120 determines that the hand of the driver is not within one of the zones A through I and/or proximate one of the command inputs 200a through 200m, the vehicle assist module 124 continues to monitor the cabin (block 400). If the motion recognition module 120 determines that the hand of the driver is within one of the zones A through I and/or proximate one of the command inputs 200a through 200m, the vehicle assist module 124 increments a corresponding counter for the particular zone and/or the particular one of the command inputs 200a through 200m (block 412). In some examples, the vehicle assist module 124, from time to time (e.g., every five seconds, every ten seconds, etc.) automatically decrements the counters for the zones A through I and/or the command inputs 200a through 200m. The vehicle assist module 124 determines whether the counter incremented at block 412 satisfies (e.g., is greater than or equal to) a first threshold (e.g., three, five, ten, etc.) (block 414). The first threshold is configured to detect when the driver reaches towards one of the command inputs 200a through 200m repeatedly in a relatively short period of time. If the counter incremented at block 412 satisfies the first threshold, the vehicle assist module 124 displays (e.g., via the center console display 114) information regarding a particular one of the zones A through I and/or a particular one of the command inputs 200a through 200m at a first level of detail (block 408). Otherwise, if the counter incremented at block 412 does not satisfy the first threshold, the vehicle assist module 124 continues to monitor the cabin (block 400).

After displaying the information at the first level of detail, the vehicle assist module 124 continues to monitor the cabin (block 416). The speech recognition module 122 listens for if the user has said the prompt phrase (block 418). If the speech recognition module 122 determines that the user has said the prompt phrase, the speech recognition module 122 interprets the speech following the prompt phrase (block 420). In some examples, the speech recognition module 122 sends the speech after the prompt phrase to the central speech recognition service 108 for further processing (e.g., to interpret natural language, etc.). The speech recognition module 122 determines whether the user requested further information regarding the subsystem and/or one of the command inputs 200a through 200m for which information was displayed at the first level of detail at block 408 (block 422). If the speech recognition module 122 determines that the user did request further information, the vehicle assist module 124 displays relevant information at a second level of detail (block 424). In some examples, the information at the second level of detail is stored in the central assistance database 110. If the speech recognition module 122 determines that the user did not request further information, the vehicle assist module 124 displays information regarding what the user did request at a first level of detail (block 408).

If the speech recognition module 122 determines that the user has not said the prompt phrase at block 402, the motion recognition module 120 determines if the hand of the driver is within the zones A through I and/or proximate the one of the command inputs 200a through 200m of which the first threshold was satisfied at block 414 (block 426). If so, the vehicle assist module 124 displays relevant information at a second level of detail (block 424). Otherwise, the vehicle assist module 124 continues to monitor the cabin (block 400).

A processor (such as the processor 316 of FIG. 3) executes the flowchart of FIG. 4 to cause the vehicle 103 to implement the motion recognition module 120, the speech recognition module 122, the vehicle assist module and/or, more generally, the vehicle assistance unit 106 of FIG. 1. Further, although the example program is described with reference to the flowchart illustrated in FIG. 8, many other methods of implementing the example motion recognition module 120, the example speech recognition module 122, the example vehicle assist module and/or, more generally, the example vehicle assistance unit 106 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a camera;
a microphone; and
a vehicle assist unit configured to:
in response to detecting a request for information regarding a subsystem of the vehicle via at least one of the camera or the microphone, display information about the subsystem at a first level of detail; and
in response to detecting a request for more information regarding the subsystem, display information about the subsystem at second level of detail.

2. The vehicle of claim 1, wherein to detect the request for information regarding the subsystem of the vehicle, the vehicle assist unit is configured to track, with the camera, a hand of a driver of the vehicle.

3. The vehicle of claim 2, wherein vehicle assist unit is configured to detect the request for information regarding the subsystem when the hand is proximate to a control of the subsystem for a threshold period of time.

4. The vehicle of claim 2, wherein vehicle assist unit is configured to detect the request for information regarding the subsystem when the hand approaches a control of the subsystem a threshold number of times in a period of time.

5. The vehicle of claim 2, wherein vehicle assist unit is configured to:
receive, via the microphone, a prompt phrase spoken by an occupant of the vehicle; and
detect the request for information regarding the subsystem when the hand is proximate a control of the subsystem and the vehicle assist unit receives the prompt phrase.

6. The vehicle of claim 1, wherein the information about the subsystem at the first level of detail includes is stored in memory of the vehicle assist unit.

7. The vehicle of claim 6, wherein the information about the subsystem at the first level of detail includes contents of a user's manual for the vehicle.

8. The vehicle of claim 1, wherein the information about the subsystem at the second level of detail includes is stored by a server remote from the vehicle.

9. The vehicle of claim 8, wherein the information about the subsystem at the second level of detail includes at least one of a video, real-time compiled information based on customer comments to call centers, a summary of dealer technical comments, and compiled online user comments.

10. A method comprising:
in response to detecting a request for information regarding a subsystem of a vehicle via at least one of a camera or a microphone, displaying, on a center console display of the vehicle, information about the subsystem at a first level of detail; and
in response to detecting a request for more information regarding the subsystem, displaying, on the center console display of the vehicle, information about the subsystem at second level of detail.

11. The vehicle of claim 10, wherein to detect the request for information regarding the subsystem of the vehicle, tracking, with the camera, a hand of a driver of the vehicle.

12. The vehicle of claim 11, including detecting the request for information regarding the subsystem when the hand is proximate a control of the subsystem for a threshold period of time.

13. The vehicle of claim 11, including detecting the request for information regarding the subsystem when the hand approaches a control of the subsystem a threshold number of times in a period of time.

14. The vehicle of claim 11, including:
receiving, via the microphone, a prompt phrase spoken by an occupant of the vehicle; and
detecting the request for information regarding the subsystem when the hand is proximate a control of the subsystem and the vehicle assist unit receives the prompt phrase.

15. The vehicle of claim 10, wherein the information about the subsystem at the first level of detail includes is stored in memory of the vehicle assist unit.

16. The vehicle of claim 15, wherein the information about the subsystem at the first level of detail includes contents of a user's manual for the vehicle.

17. The vehicle of claim 10, wherein the information about the subsystem at the second level of detail includes is stored by a server remote from the vehicle.

18. The vehicle of claim 17, wherein the information about the subsystem at the second level of detail includes at least one of a video, real-time compiled information based on customer comments to call centers, a summary of dealer technical comments, and compiled online user comments.

19. A tangible computer readable medium comprising instructions that, when executed, cause a vehicle to:
in response to detecting a request for information regarding a subsystem of a vehicle via at least one of a camera or a microphone, display, on a center console display of the vehicle, information about the subsystem at a first level of detail; and
in response to detecting a request for more information regarding the subsystem, display, on the center console display of the vehicle, information about the subsystem at second level of detail.
